(19) United States
(12) Patent Application Publication
(10) Pub. No.: US 2012/0125284 A1
(43) Pub. Date: May 24, 2012

(54) Motorcycle Engine Crankcase for Simplified Engine Installation and Method of Installing the Same

(75) Inventors: Brian D. Brace, Columbia, IL (US); John M. Garrison, Arnold, MO (US)

(73) Assignee: MIDWEST MOTORCYCLE SUPPLY DISTRIBUTORS CORP., Pevely, MO (US)

(21) Appl. No.: 12/954,309

(22) Filed: Nov. 24, 2010

(51) Int. Cl. F02F 7/00; B23P 11/00

(52) U.S. Cl. 123/195 R; 29/428

(57) ABSTRACT

A motorcycle crankcase is configured to support a crankshaft in a manner such that the crankshaft is rotatable about a crankshaft axis. The motorcycle crankcase comprises a pair of piston cylinder mounts, first and second horizontally oriented downward facing mounting surfaces, a generally semi-cylindrical bottom surface, and a plurality of crankcase bolt lugs. The pair of piston cylinder mounts are configured and adapted to rigidly connect to a pair of piston cylinders oriented in an upright V-twin style manner. The first and second mounting surfaces are configured and adapted to secure the motorcycle crankcase to a motorcycle frame. The crankcase bolt lugs are spaced about the crankshaft axis and each of the crankcase bolt lugs partially protrudes radially outward from the bottom surface. The motorcycle crankcase is devoid of any portion positioned directly beneath the first mounting surface.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The present invention pertains to motorcycles. More particularly, this invention pertains to a motorcycle engine crankcase that is adapted and configured to allow a motorcycle engine to be installed on a standard motorcycle frame without difficult maneuvering steps.

2. Related Art

A common type of motorcycle comprises a frame and V-twin air-cooled engine. On many of such motorcycles the crankshaft rotates about an axis that is oriented side-to-side relative to the motorcycle and the engine fits within a very confined space between frame members. Such an engine is typically supported by the frame via two mounts that support the crankcase and one other mount that supports the two piston cylinders. This is the manner in which most Harley Davidson® V-twin motorcycles are configured.

The crankcase of such motorcycles typically comprises a plurality of lugs for the crankcase bolts. Those crankcase bolt lugs protrude radially outward from the bottom semi-cylindrical surface of the crankcase so as to minimize the amount of metal needed to cast the crankcase. The two mounting surfaces on the crankcase face down and are on opposite sides of the crankshaft axis above the bottom surface of the crankcase. In order to install of this type of engine onto a motorcycle frame, the engine must be pivoted about all three principal axes and must be translated in all three principal directions. This is a result of the fact that a lug protrudes beneath each of the two mounting surfaces of the crankcase and therefore the engine cannot simply be lowered onto the crankcase mounts of the motorcycle frame. Due to the significant “jockeying” required to install the engine onto a motorcycle frame, it is not uncommon to inadvertently damage the paintjob of the motorcycle frame and it is very difficult and time consuming to install such an engine.

### SUMMARY OF THE INVENTION

The present invention eliminates the problems associated with installing a V-twin engine on a Harley Davidson® style motorcycle. This is achieved by utilizing a crankcase with a unique crankcase bolt lug configuration that does not interfere engine installation.

In one aspect of the invention, a motorcycle crankcase is configured to support a crankshaft in a manner such that the crankshaft is rotatable about a crankshaft axis (the crankshaft axis defining axial, radial, and circumferential directions). The motorcycle crankcase comprises a pair of piston cylinder mounts, first and second horizontally oriented downward facing mounting surfaces, a generally semi-cylindrical bottom surface, and a plurality of crankcase bolt lugs. The pair of piston cylinder mounts are configured and adapted to rigidly connect to a pair of piston cylinders oriented in an upright V-twin style manner. The first and second mounting surfaces are on opposite sides of the crankshaft axis above the bottom surface and are configured and adapted to secure the motorcycle crankcase to a motorcycle frame. The bottom surface is generally aligned with the crankshaft axis. The crankcase bolt lugs are circumferentially spaced about the crankshaft axis and each of the crankcase bolt lugs partially protrudes radially outward from the bottom surface. The first mounting surface is lower than the second mounting surface and the motorcycle crankcase is devoid of any portion positioned directly beneath the first mounting surface.

Another aspect of the invention pertains to a method of attaching an engine to a motorcycle frame. The engine comprises an crankcase, a crankshaft, a pair of piston cylinders, and a pair of cylinder heads. The pair of piston cylinders extend from the crankcase in a V-style manner. The cylinder heads are attached to the piston cylinders in manner such that each of the piston cylinders lies between the crankcase and a respective one of the cylinder heads. The crankshaft is rotatable about a crankshaft axis. The crankcase comprises a generally semi-cylindrical bottom surface and first and second parallel mounting surfaces. The bottom surface is generally aligned with the crankshaft axis. The first and second mounting surfaces face in direction opposite the cylinders and are on opposite sides of the crankshaft axis. The motorcycle frame comprises first and second engine mounts and two generally parallel and spaced apart frame member portions. The frame member portions defining a plane. The method of attaching the engine to the frame comprises, initially moving the engine from an environment external to the motorcycle frame and to a first orientation relative to the motorcycle frame wherein a portion of the bottom surface of the crankcase lies between the frame member portions and between the first and second crankcase mounts and the crankshaft axis is oriented at an angle relative to the plane defined by the frame member portions, all while the crankshaft axis is maintained generally perpendicular to each of the frame member portions. The method further comprises, pivoting the engine in a plane that is generally perpendicular to each of the frame member portions from the first orientation to a second orientation while the crankshaft axis is maintained generally perpendicular to each of the frame member portions. The first mounting surface of the crankcase is engaged with the first engine mount and the second mounting surface of the crankcase is engaged with the second engine mount when the engine is in the second orientation. Furthermore, the crankshaft axis is parallel to the plane defined by the frame member portions when the engine is in the second orientation. The method still further comprises, securing the engine to the motorcycle frame in the second orientation.

Further features and advantages of the present invention, as well as the operation of the preferred embodiment of the present invention, are described in detail below with reference to the accompanying drawings.

### BRIEF DESCRIPTION OF THE DRAWINGS

FIG. 1 depicts a prior art motorcycle crankcase on prior art crankcase mounts of a motorcycle frame.

FIG. 2 depicts a motorcycle crankcase of the present invention on the prior art crankcase mounts of the motorcycle frame.

FIG. 3 depicts a side view of the prior art motorcycle crankcase mounted to a prior art motorcycle frame.

FIG. 4 depicts a side view of the motorcycle crankcase of the present invention mounted to the prior art motorcycle frame.

FIG. 5 depicts a front view of the prior art motorcycle frame as the motorcycle crankcase of the present invention is being mounted to the motorcycle frame.

FIG. 6 depicts a top view of the prior art motorcycle frame as the motorcycle crankcase of the present invention is being mounted to the motorcycle frame.

FIG. 7 depicts a side view of the prior art motorcycle frame as the motorcycle crankcase of the present invention is being mounted to the motorcycle frame.

FIG. 8 depicts a bottom view of the prior art motorcycle frame as the motorcycle crankcase of the present invention is being mounted to the motorcycle frame.

Reference numerals in the written specification and in the drawing figure indicate corresponding items.

### DETAILED DESCRIPTION OF THE PREFERRED EMBODIMENT

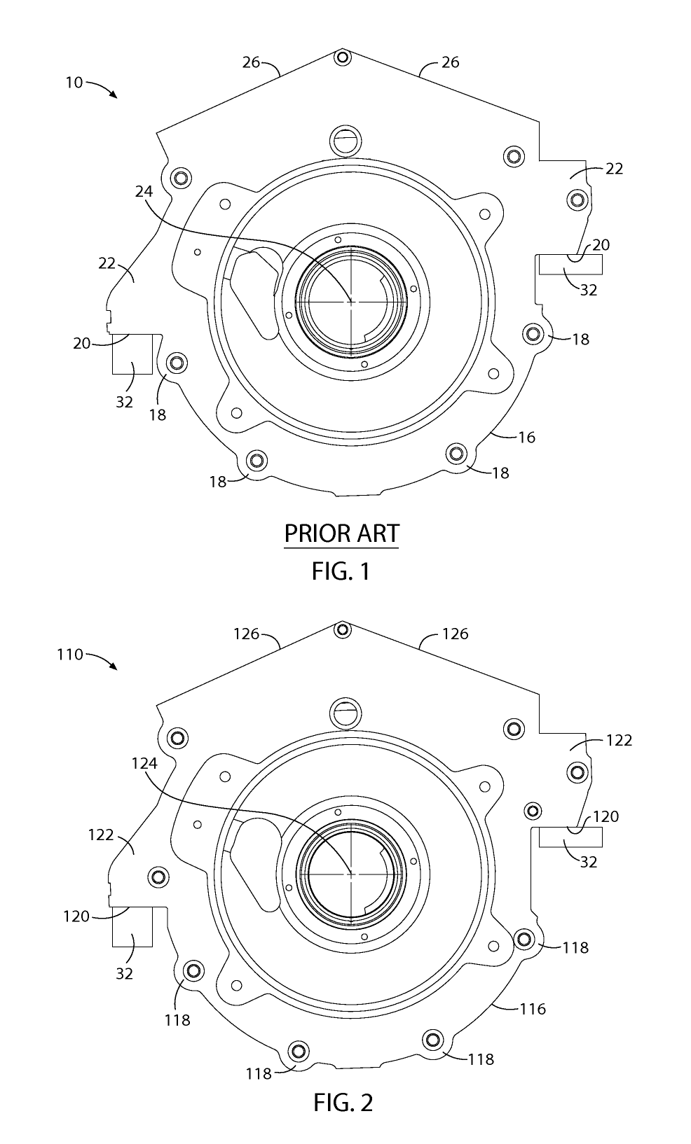

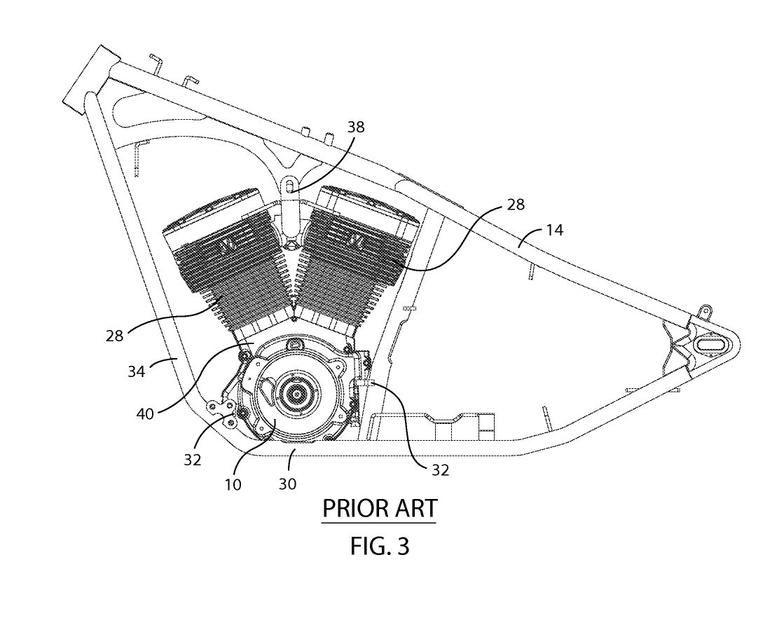

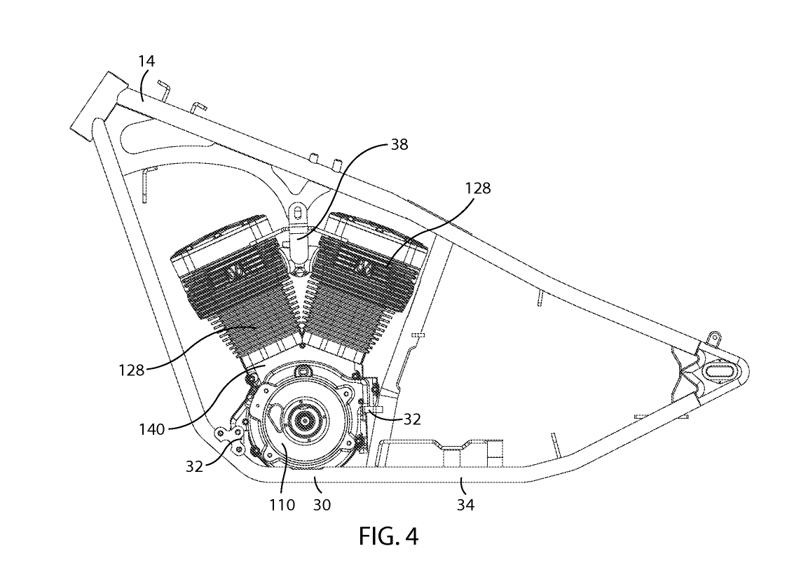

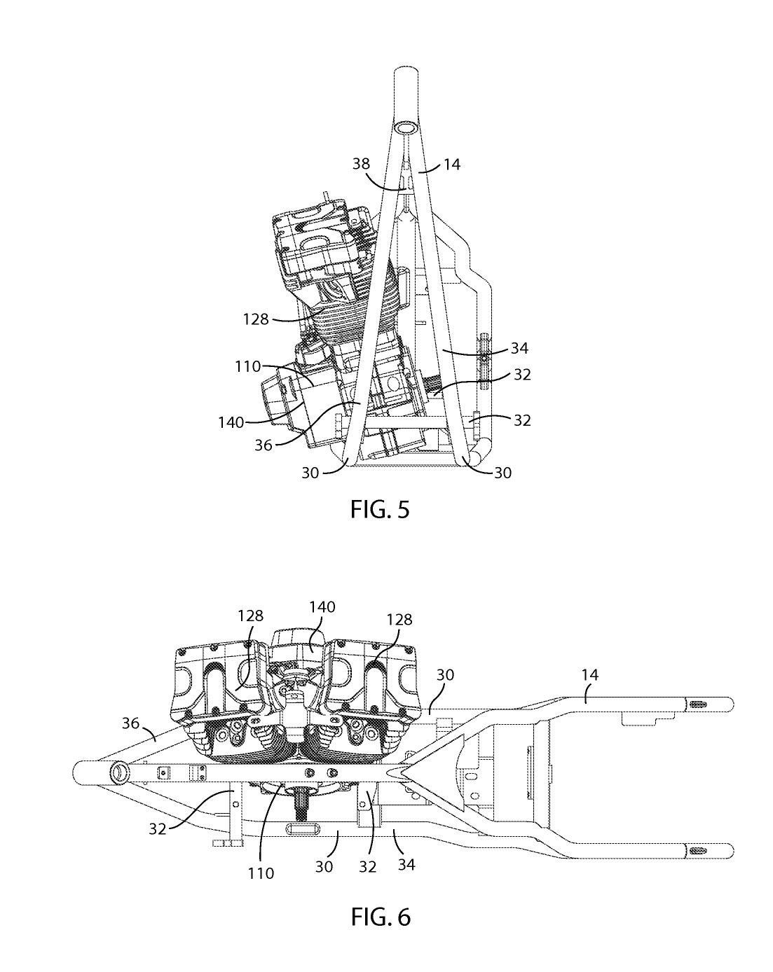

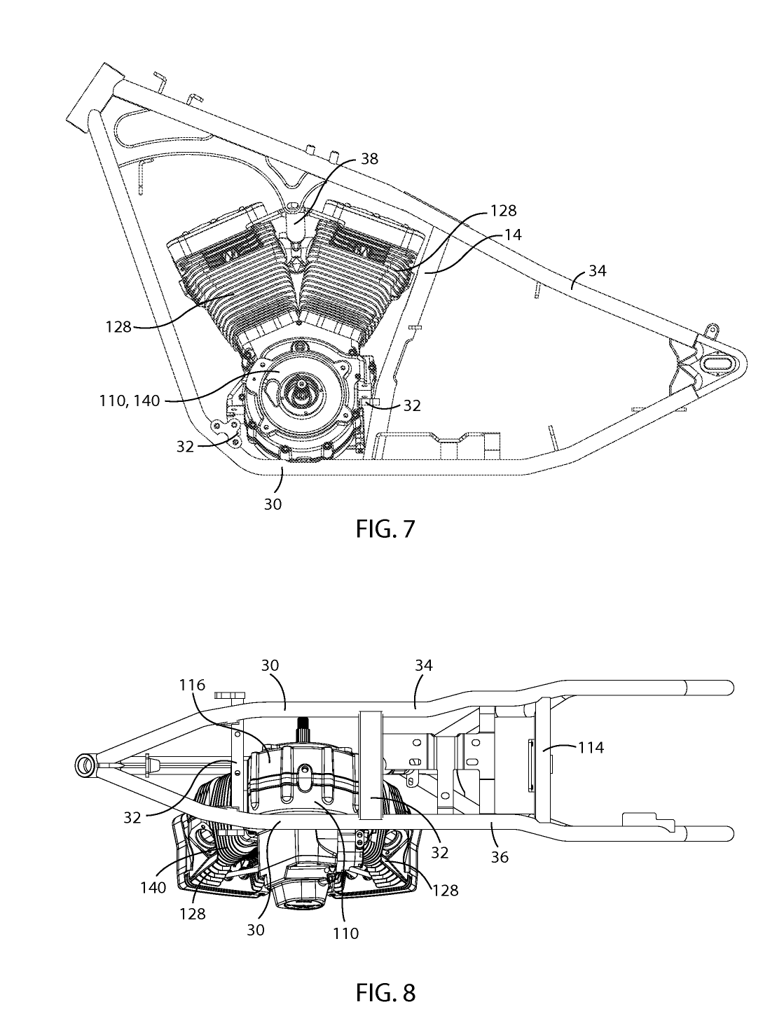

A prior art motorcycle crankcase 10 is depicted in FIG. 1 mounted on a prior art motorcycle frame 14. As shown, the bottom surface 16 of the crankcase 10 has a shape of approximately half of a cylinder. The crankcase 10 also comprises a plurality of lugs 18 for crankcase bolts (not shown) that bulge radially outward from the bottom surface 16. Still further, the crankcase 10 comprises a pair of downward facing mounting surfaces 20 formed on the bottom of two mounting protrusions 22. The mounting surfaces 20 lie on opposite sides of the crankshaft axis 24. The top of the crankcase 10 comprises a pair of sloped cylinder mounting faces 26 that are configured and adapted to support a pair of piston cylinders 28 (see FIG. 3) in a V-style manner. As used herein, “piston cylinder” refers to the cylinder wall and head as an assembly.

As shown in FIG. 3, the prior art crankcase 10 is configured and adapted to be secured to a motorcycle frame 14 in a manner such that the crankshaft axis 24 lies horizontal and extends side-to-side (i.e., widthwise relative to the motorcycle frame). The prior art motorcycle frame 14 comprises left and right lower frame member portions 30 that are spaced apart and extend horizontally in a front-to-back direction. The frame 14 also comprises a pair of crankcase mounts 32 that extend horizontally. The forward-most crankcase mount 32 connects the left side 34 of the frame to the right side 36 of the frame. Still further, the frame 14 comprises a removable an upper engine mount 38. The crankcase mounts 32 are configured to engage against the mounting surfaces 20 of the crankcase 10 and to be bolted to the mounting protrusions 22 of the crankcase. The upper engine mount 38 is configured to attach to and support the engine 40 from the engine's piston cylinders 28.

As shown in FIGS. 1 and 3, when attached to the frame 14, the prior art engine 40 is only slightly spaced from various portions of the frame and a portion of the bottom surface 16 of the crankcase 10 lies between the lower frame member portions 30. Thus, the engine 40 cannot merely be slid onto the crankcase mounts 32 from the side, and great care must be taken to avoid contact between the engine 40 and portions of the frame 14 when the engine is being installed. Even slight contact can damage what is often an expensive custom paintjob on the frame 14. Unfortunately, avoiding such contact requires extreme finesse and skill due to the manner in which the engine 40 must be brought to rest on the crankcase mounts 32 of the frame 14. As is shown in FIG. 1, the forward-most portion of the forward-most lug 18 of the prior art crankcase 10 is spaced from the rearward-most portion of the rearward-most lug by a distance that is greater than the horizontal distance between the crankcase mounts 32 of the frame 14. Moreover, the forward-most portion of the forward-most lug 18 lies directly beneath the forward mounting surface 20 of the crankcase 10, and the rearward-most portion of the rearward most lug lies directly beneath the rearward mounting surface of the crankcase. In view of these features, the prior art engine 40 cannot be simply lowered vertically onto the frame 14 since the lugs 18 of the crankcase 10 would not fit between the crankcase mounts 32 of the frame 14. Thus, to assemble the prior art engine 40 to the frame 14, it is necessary to simultaneously roll, yaw, lower, and translate the engine in a complex manner. This makes it difficult to avoid damaging the paintjob of the frame 14.

A crankcase 110 in accordance with the present invention is shown in FIG. 2 and provides for easier installation of an engine onto a standard prior art style frame. Many aspects of this new crankcase 110 are similar to those of the prior art crankcase 10 and therefore need not by described again. Nonetheless, the reference numerals associated with the new crankcase 110 correlate to those associated with the prior art crankcase 10, except they are greater by one hundred. Thus, for example, the mounting protrusions of the prior art crankcase are labeled 22 and the mounting protrusions of the new case are labeled 122.

Unlike the prior art crankcase 10, the forward-most lug 118 of new crankcase 110 does not extend directly beneath the forward-most mounting surface 120 of the crankcase. Moreover, the forward-most portion of the forward-most crankcase bolt lug 118 of the crankcase 110 is spaced from the rearward-most portion of the lower rearward-most lug by a distance that is less than the horizontal distance between the crankcase mounts 32 of the frame 14. Still further, although the rearward-most portion of the rearward-most lug 118 does lie directly beneath the rearward-most mounting surface 120 of the crankcase 110, it is space vertically therefrom by more than two inches. These features dramatically ease the assembly of an engine 140 comprising the new crankcase 110 onto a standard motorcycle frame 18, as compared to the prior art. For example, an engine 140 comprising the new crankcase 110 can be assembled onto a standard prior art motorcycle frame 14 simply by rolling and lowering the engine 140 onto the frame 18, without also having to yaw or pitch the engine. As a result, the rearward most portion of the aft cylinder 128 never extends further aft during installation than it is when installed. This makes damaging the paintjob of the frame during assembly highly unlikely. This also allows the assembly to be performed with relative ease and speed.

In view of the foregoing, it should be appreciated that various advantages and benefits are achieved by the invention. As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

It should also be understood that when introducing elements of the present invention in the claims or in the above description of the preferred embodiment of the invention, the terms “comprising,” “including,” and “having” are intended to be open-ended and mean that there may be additional elements other than the listed elements. Additionally, the term “portion” should be construed as meaning some or all of the item or element that it qualifies. Moreover, use of identifiers such as first, second, and third should not be construed in a manner imposing any relative position or time sequence between limitations. Still further, the order in which the steps of any method claim that follows are presented should not be construed in a manner limiting the order in which such steps must be performed.

What is claimed is:

1. A motorcycle crankcase configured to support a crankshaft in a manner such that the crankshaft is rotatable about a crankshaft axis, the crankshaft axis defining axial, radial, and circumferential directions, the motorcycle crankcase comprising a pair of piston cylinder mounts, first and second horizontally oriented downward facing mounting surfaces, a generally semi-cylindrical bottom surface, and a plurality of crankcase bolt lugs, the pair of piston cylinder mounts being configured and adapted to rigidly connect to a pair of piston cylinders oriented in an upright V-style manner, the first and second mounting surfaces being on opposite sides of the crankshaft axis above the bottom surface and being configured and adapted to secure the motorcycle crankcase to a motorcycle frame, the bottom surface being generally aligned with the crankshaft axis, the crankcase bolt lugs being circumferentially spaced about the crankshaft axis, each of the crankcase bolt lugs partially protruding radially outward from the bottom surface relative to the crankshaft axis, the first mounting surface being lower than the second mounting surface, the motorcycle crankcase being devoid of any portion positioned directly beneath the first mounting surface.

2. A motorcycle crankcase in accordance with claim 1 wherein the motorcycle crankcase is devoid of any portion positioned directly beneath the second mounting surface within two inches below the second mounting surface.

3. A motorcycle comprising, a motorcycle frame and a motorcycle crankcase in accordance with claim 1, the motorcycle frame comprising first and second crankcase mounts and two generally parallel and spaced apart frame member portions, the frame member portions extending generally horizontal and perpendicular to the crankcase axis, a portion of the bottom surface of the crankcase being positioned directly between the frame member portions, the first crankcase mount of the motorcycle frame being in contact with and secured to the first mounting surface of the motorcycle crankcase, the second crankcase mount of the motorcycle frame being in contact with and secured to the second mounting surface of the motorcycle crankcase.

4. A motorcycle in accordance with claim 3 wherein the motorcycle crankcase is devoid of any portion positioned directly beneath the second mounting surface within two inches below the second mounting surface.

5. A motorcycle in accordance with claim 4 wherein one of the crankcase bolt lugs constitutes a forward most crankcase bolt lug and another one of the crankcase bolt lugs constitutes a rearward-most crankcase bolt lug, the forward most crankcase bolt lug is nearest to the first mounting surface, the rearward most crankcase bolt lug is nearest to the second mounting surface, the first crankcase mount is horizontally spaced from the second crankcase mount by a first distance, and all portions of the forward-most crankcase bolt lug and the rearward-most crankcase bolt lug are horizontally spaced apart less than first distance.

6. A motorcycle in accordance with claim 3 wherein one of the crankcase bolt lugs constitutes a forward most crankcase bolt lug and another one of the crankcase bolt lugs constitutes a rearward-most crankcase bolt lug, the forward most crankcase bolt lug is nearest to the first mounting surface, the rearward most crankcase bolt lug is nearest to the second mounting surface, the first crankcase mount is horizontally spaced from the second crankcase mount by a first distance, and all portions of the forward-most crankcase bolt lug and the rearward-most crankcase bolt lug are horizontally spaced apart less than first distance.

7. A method comprising placing a motorcycle crankcase in accordance with claim 1 onto a motorcycle frame in a mounting position and securing the motorcycle crankcase to the motorcycle frame with the motorcycle crankcase in the mounting position.

8. A method in accordance with claim 7 wherein the motorcycle frame comprises two generally parallel and spaced apart frame member portions and wherein the crankshaft axis is maintained generally perpendicular to the frame member portions as the motorcycle crankcase is placed onto the motorcycle frame in the mounting position from a position external to the motorcycle frame.

9. A method in accordance with claim 8 wherein a portion of the bottom surface of the crankcase is inserted between the frame member portions as the motorcycle crankcase is being placed onto the motorcycle frame.

10. A method in accordance with claim 9 wherein the motorcycle crankcase is devoid of any portion positioned directly beneath the second mounting surface within two inches below the second mounting surface.

11. A method in accordance with claim 9 wherein the motorcycle frame comprises first and second crankcase mounts, the frame member portions extend generally horizontal, the first crankcase mount of the motorcycle frame is in contact with and secured to the first mounting surface of the motorcycle crankcase when the motorcycle crankcase is secured to the motorcycle frame , the second crankcase mount of the motorcycle frame is in contact with and secured to the second mounting surface of the motorcycle crankcase when the motorcycle crankcase is secured to the motorcycle frame, one of the crankcase bolt lugs constitutes a forward most crankcase bolt lug and another one of the crankcase bolt lugs constitutes a rearward-most crankcase bolt lug, the forward most crankcase bolt lug is nearest to the first mounting surface, the rearward most crankcase bolt lug is nearest to the second mounting surface, the first crankcase mount is horizontally spaced from the second crankcase mount by a first distance, and all portions of the forward-most crankcase bolt lug and the rearward-most crankcase bolt lug are horizontally spaced apart less than first distance.

12. A method of attaching an engine to a motorcycle frame, the engine comprising an crankcase, a crankshaft, a pair of piston cylinders, and a pair of cylinder heads, the pair of piston cylinders extending from the crankcase in a V-style manner, the cylinder heads being attached to the piston cylinders in manner such that each of the piston cylinders lies between the crankcase and a respective one of the cylinder heads, the crankshaft being rotatable about a crankshaft axis, the crankcase comprising a generally semi-cylindrical bottom surface and first and second parallel mounting surfaces, the bottom surface being generally aligned with the crankshaft axis, the first and second mounting surfaces facing in direction opposite the cylinders and being on opposite sides of the crankshaft axis, the motorcycle frame comprising first and second engine mounts and two generally parallel and spaced apart frame member portions, the frame member portions defining a plane, the attaching of the engine to the frame comprising:
initially moving the engine from an environment external to the motorcycle frame and to a first orientation relative to the motorcycle frame wherein a portion of the bottom surface of the crankcase lies between the frame member portions and between the first and second crankcase mounts and the crankshaft axis is oriented at an angle relative to the plane defined by the frame member portions, all while the crankshaft axis is maintained generally perpendicular to each of the frame member portions;
pivoting the engine in a plane that is generally perpendicular to each of the frame member portions from the first orientation to a second orientation while the crankshaft axis is maintained generally perpendicular to each of the frame member portions, the first mounting surface of the crankcase being engaged with the first engine mount and the second mounting surface of the crankcase being engaged with the second engine mount when the engine is in the second orientation, the crankshaft axis being parallel to the plane defined by the frame member portions when the engine is in the second orientation; and
securing the engine to the motorcycle frame in the second orientation.

13. A method in accordance with claim 12 wherein the engine is lowered as the engine is pivoted from the first orientation to the second orientation.
